(19) United States
(12) Patent Application Publication
(10) Pub. No.: US 2021/0218724 A1
(43) Pub. Date: Jul. 15, 2021

(54) INFORMATION PROCESSING SYSTEM, NODE, AUTHENTICATION METHOD, AND RECORDING MEDIUM WHEREON PROGRAM FOR SAME HAS BEEN RECORDED

(71) Applicant: NEC Corporation, Minato-ku, Tokyo (JP)

(72) Inventors: Haruna FUKUDA, Tokyo (JP); Toshiyuki ISSHIKI, Tokyo (JP); Hiroto TAMIYA, Tokyo (JP)

(73) Assignee: NEC Corporation, Minato-ku, Tokyo (JP)

(21) Appl. No.: 16/771,962

(22) PCT Filed: Dec. 14, 2017
(86) PCT No.: PCT/JP2017/044892

§ 371 Date: Jun. 11, 2020

(51) Int. Cl. H04L 29/06

(52) U.S. Cl. CPC H04L 63/083; H04L 63/20; H04L 63/102; H04L 63/0876

(57) ABSTRACT

An objective of the present invention is to enable user authentication with an intensity that is in accordance with a current situation. In the present invention, a situation management device retains a current situation of an overall system including a relevant system being connected and an operator. A registration device: accepts registration information; and stores the registration information and/or information associated with the registration information as storage information in a storage device. An authentication device: accepts authentication information; and outputs the authentication information and/or information associated with the authentication information as comparison information. A comparison device compares the storage information acquired at the time of registration and the comparison information acquired at the time of authentication using a reference that is in accordance with the current situation of the overall system, such as normal operation or a malfunction, and carries out an operator authentication accordingly.

### TECHNICAL FIELD

This invention relates to an information processing system, a node, an authentication method, and a recording medium whereon a program for same has been recorded and, more particularly, to an information processing system, a node, an authentication method, and a recording medium whereon a program for same has been recorded, which carry out authentication of a user based on a criterion in accordance with a situation.

### BACKGROUND ART

In a social infrastructure such as electric power, gas, and tapwater, and in a plant such as a petrochemical facility or a manufacturing facility, an industrial control system, which is a system for managing, instructing, and controlling operations of respective apparatuses, has been introduced. By introducing the industrial control system partially automated, it becomes possible to carry out efficient supply, production, and management in the plant. An operator carries out an operation such as inputting of control values from a part of operation-only terminals. Thereby, control of an apparatus is carried out based on the inputted control values and measurement values from sensors.

The industrial control system as mentioned above has an influence upon a wider range. For instance, in Japan, with respect to energies such as electric power, gas, and tapwater, an energy related to the same system is used by a lot of people across a plurality of local governments. In addition, the industrial control system also has a feature that its influence is large. For instance, not only it is recognized normal that the social infrastructure is operating, but also suspension thereof may lead to a crisis of life. In addition, like a smelting furnace of an iron mill, there is a system which cannot be restarted once it is stopped. Accordingly, in order to avoid a serious adverse effect exerted over a wide area, it is necessary to design a system which can carry out minimum control upon occurrence of an abnormality as well as under normal conditions.

Causes of the abnormality of the industrial control system may be a fault of the apparatus, a disaster, a cyber-security incident, or the like. In recent years, for the purpose of an efficiency of control or improvement of productivity, a lot of industrial control systems have been connected to the Internet. At the same time, this results in increase in possibility of a cyberattack and a malware infection to the industrial control systems via the Internet. The cyber-security incident exerting serious influence such as suspension of a power generation function has already occurred. As well as a need to take countermeasures against the cyberattack, system design, which can continue proper control upon occurrence of abnormality also, becomes more important.

As described above, a manual operation is carried out in the industrial control system. Like an information system, in order to prevent illegal control by an unauthorized operator, it is desirable to carry out authentication of the operator in an operation terminal. In view of the above, Non-Patent Literature 1, which is a security guideline for the industrial control system issued by National Institute of Standards and Technology (NIST), also recommends to carry out the authentication of the operator. However, Non-Patent Literature 1 also describes that the authentication of the operator is unsuitable especially upon occurrence of abnormality. The reason is as follows. For instance, in a case of password authentication, a user's ability to recall and enter a password may be affected by a user's stress at that moment, namely, a mental condition (state of mind) of the operator. Accordingly, upon occurrence of abnormality, the user (operator) may input a wrong password and may be locked out. In addition, Non-Patent Literature 1 describes that there is similar problems in a case of biometric authentication also. Furthermore, it is not desirable to carry out authentication using a personal belonging such as a smart card. This is because there is a risk that the user (operator) misses, loses, or damages the personal belonging. From such a background, authentication of the operator is not carried out in many industrial control systems.

On the other hand, Non-Patent Literature 2 illustrates results of research carried out about input mistakes of the user (operator) in password authentication. Non-Patent Literature 2 shows, as examples of common input mistakes, six kinds of mistakes as follows. A first mistake is a mistake of entirely replacing uppercase letters and lowercase letters due to Caps Lock setting errors. A second mistake is a mistake of erroneously entering the uppercase letter or the lowercase letter mainly at the first letter. A third mistake is a mistake of replacing preceding and succeeding letters with each other. A fourth mistake is a mistake of erroneously hitting a nearby key on a keyboard. A fifth mistake is a mistake of repeatedly hitting the same key. A sixth mistake is a mistake of repeating, a wrong number of times, the key to be repeatedly hit. For example, the common input mistakes for a password such as “password” include “PASSWORD”, “Password”, “apssword”, “oassword”, “paassword”, “passsword”, “pasword”, and so on. Furthermore, Non-Patent Literature 2 proposes a password authentication system for accepting, for a registered password, an input mistake frequently made by the user (operator).

Non-Patent Literature 3 describes that accuracy of biometric authentication is reduced due to differences in image taking positions, degrees of skin roughness and contamination, and so on between at the time of registration and at the time of authentication. The biometric authentication determines, based on a degree of approximation between registered biological information and biological information used at the time of authentication, whether or not they are acquired from the same person. Accordingly, the degree of approximation between two pieces of the biological information is reduced due to the differences in image taking position, degrees of skin roughness and contamination, and so on between at the time of registration and at the time of authentication. As a result, a possibility of unsuccessful authentication becomes high even in case of the same person.

Various Patent Literatures related to the present invention have been proposed.

For instance, Patent Literature 1 discloses an authentication apparatus which increases a permitted scope for a position of a body so as to enable a reduction in frequency of guidance in instances which are borderline as to whether or not guidance to an appropriate body position is required. Biometric information is sometimes considered unsuitable for use in authentication due to a slight fluctuation of biometric information or environmental changes. Therefore, the authentication apparatus disclosed in Patent Literature 1 reduces an influence of such fluctuation of biometric information or environmental changes by correcting the biometric information. The authentication apparatus includes a surface information extraction unit, a surface information analysis unit, a surface information correcting unit, and an authentication unit. The surface information extraction unit extracts, from image information obtained by photographing a palm (living body), surface information which can be used for evaluating concavity/convexity of a palm surface (living body surface). The surface information is information which can be used for evaluating the concavity/convexity of the living body surface, for example, luminance information. The surface information analysis unit analyzes, from the surface information, the concavity/convexity of the palm surface. The surface information correcting unit corrects the concavity/convexity of the palm surface for the surface information. For example, the surface information correcting unit performs correction to smooth the concavity/convexity of the palm surface for the surface information. The authentication unit performs authentication using the corrected surface information.

Patent Literature 2 discloses an electronic device including a controller that changes an authentication level used to perform unlocking on locking based on a locking function according to a travel state of a user. In Patent Literature 2, a control program measures vibrations and motions applied to a smartphone (electronic device), refers to data on the vibrations and motions measured in advance, and determines a travel state from the result of measuring the vibrations and motions. In addition, the control program has a function of changing the authentication level on the basis of a first travel state that is the result of the determination made when locking is performed and a second travel state that is the result of the determination made when unlocking is performed. Furthermore, the control program acquires fingerprint data by using a fingerprint sensor in accordance with the unlocking operation and calculates a matching rate between the acquired fingerprint data and collation fingerprint data that is set and registered in advance. When it is determined that the calculated matching rate satisfies an unlocking condition, the control program has the function of performing unlocking. In this event, the control program is able to provide a function of determining an unlocking condition on the basis of the authentication level. The travel state includes a state where the subject device is placed on a still object, a stopping state where the user who carries the subject device is stopping, a walking state where the user who carries the subject device is walking, a running state where the user who carries out the subject device is running, and an on-state where the user who carries the subject device is on an automobile or a train.

Patent Literature 3 discloses a power management system capable of preventing a vehicle from starting moving in a state where a cable is connected. In the power management system disclosed in Patent Literature 3, a power management device comprises an input reception unit for receiving an input of authentication information by a person and a controller which includes an authentication unit and a determination unit. On the other hand, the vehicle comprises an input reception unit for receiving an input of authentication information by a person and a controller which includes a storage unit, in which second authentication information is stored, and a determination unit. When the authentication information is supplied to the input reception unit of the power management device, the authentication unit of the power management device reads the second authentication information in the storage unit of the vehicle via a communication line and performs comparison between the supplied authentication information and the second authentication information thus read. A result of the comparison is delivered to the determination unit of the power management device and is delivered to the determination unit of the vehicle via the communication line.

Patent Literature 4 discloses a printer, which reduces time and effort required in setting by an administrator by monitoring a use history of a user and automatically reflecting it to an authentication level, and which ensures security as a printing system based on the authentication level and improves print processing efficiency. The printer disclosed in Patent Literature 4 comprises a use history management unit, an authentication level determination unit, an authentication level storage unit, an authentication control unit, an authentication information storage unit. The use history management unit manages a reception history of print data such as a user, a time, and authentication necessity information. The authentication level determination unit determines raising and lowering of the authentication level based on the information of the use history management unit. The authentication level storage unit manages the authentication level for each day of week and each time zone. The authentication control unit communicates with the respective storage units and with external apparatuses to carry out authentication control. The authentication control unit includes a judgment information acquisition unit. The authentication information storage unit stores authentication information which is preliminarily set for each user. When reception of print data, for which authentication is required, is notified from an authentication determination unit to the judgment information acquisition unit in the authentication control unit, the determination information acquisition unit acquires a current authentication level from the authentication level storage unit and acquires, from the authentication information storage unit, authentication information for comparison in accordance with the authentication level.

### CITATION LIST

### Patent Literature

PTL 1: WO2012/111664A1
PTL2: JP 2017-085423 A
PTL3: JP 2012-165525 A
PTL4: JP 2012-165525 A

### Non Patent Literature

NPL 1: NIST Special Publication (SP) 800-82: Guide to Industrial Control Systems (ICS) Security, National Institute of Standards and Technology
NPL2: The TypTop System: Personalized Typo-Tolerant Password Checking, Rahul Chatterjee, Joanne Woodage, Yuval Pnueli, Anusha Chowdhury, Thomas Ristenpart 2017 ACM SIGSAC Conference on Computer and Communications Security
NPL 3: Biometrics—Personal Identification by Measurement of Biological Traits—Koichi SHIMIZU, Biomedical Engineering 44(1), 2006

### SUMMARY OF THE INVENTION

### Technical Problem

In the industrial control system, control by a person is carried out. In order to prevent illegal control by an unauthorized operator, it is desired to carry out authentication of the operator in an operation terminal. As described above, however, upon occurrence of abnormality, there are risks that the user (operator) inputs a wrong password, that, due to contamination or roughness, a living body is put into a state which is different from that at the time of registration, and that the smart card is broken. Therefore, there are risks that the operator cannot clear the authentication and the control cannot be carried out. The fact that the control cannot be carried out possibly causes suspension or an undesired operation of the industrial control system, which has a serious adverse effect over a wide range. Therefore, such a situation in which the control cannot be carried out should be avoided. As a result, a majority of the industrial control systems accept a menace of illegal operation and does not carry out appropriate authentication of the operator.

On the other hand, the authentication methods disclosed in the above-mentioned Patent Literatures 1 to 4 have problems which will be described in the following.

Patent Literature 1 merely discloses a technical idea of decreasing the influence of the fluctuation of biological information or the environmental change by correcting the acquired biological information (information of concavity/convexity of the palm surface) itself that is necessary to authentication. In other words, Patent Literature 1 does not take into account a current situation of the operator (user) itself and a current situation of an overall system including relevant systems. As a result, it is difficult in Patent Literature 1 to carry out appropriate authentication of the operator.

Patent Literature 2 merely discloses a technical idea of changing the authentication level based on the travel state of the user (specifically, the state of the electronic device operated by the user) alone. Accordingly, Patent Literature 2 also does not take into account the current situation of the operator (user) itself and the current situation of the overall system including the relevant systems. It is therefore difficult in Patent Literature 2 to carry out appropriate authentication of the operator.

Patent Literature 3 merely discloses a well-known technical idea of carrying out authentication by comparing the authentication information supplied from the input reception unit and the authentication information which is stored in the storage unit and which is used for authentication.

Patent Literature 4 merely discloses a technical idea of changing the current authentication level based on the past use history of the user or the like. Accordingly, Patent Literature 4 also does not take into account the current situation of the operator (user) itself and the current situation of the overall system including the relevant systems. It is therefore difficult in Patent Literature 4 to carry out appropriate authentication of the operator.

In view of the above, there is a demand for an authentication system for carrying out appropriate authentication of an operator, taking into account a trade-off between usability and security, in accordance with a current situation of an operator and/or of an overall system including relevant systems connected thereto.

It is an object of this invention to provide an information processing system, a node, an authentication method, and a recording medium whereon a program for same has been recorded, which are capable of resolving the above-mentioned problems.

### Solution to Problem

An information processing system according to an aspect of the present invention comprises a situation management device configured to hold a current situation of an operator and/or of an overall system including relevant systems connected thereto; a registration device configured to: receive registration information; and to store, as stored information in a storage device, at least one of the registration information and information associated with the registration information as it is or after converting the at least one using a predetermined conversion function; an authentication device configured to: receive authentication information; and to produce, as comparison information, at least one of the authentication information and information associated with the authentication information as it is or after converting the last at least one using the predetermined conversion function; and a comparison device configured to compare the stored information with the comparison information in accordance with the current situation.

A situation management device being a node according to an aspect of the present invention comprises a situation holding unit configured to hold a current situation of an operator and/or of an overall system including relevant systems connected thereto; and a situation changing unit configured to receive a situation changing request and to change the current situation held in the situation holding unit.

A registration device being a node according to an aspect of the present invention comprises a registration information input unit configured to receive registration information; and an allowed information generation unit configured to generate at least one piece of allowed information as information associated with the registration information.

A comparison device being a node according to an aspect of the present invention comprises an authentication information acquisition unit configured to receive authentication information from an authentication device; a current situation acquisition unit configured to acquire, from a situation management device, a current situation of an operator and/or of an overall system including relevant systems connected thereto; a stored information acquisition unit configured to selectively acquire, from a storage device, stored information in accordance with the current situation; an information comparison unit configured to compare the authentication information with the selected stored information to produce a compared result; and a result determination unit configure to determine an authenticated result based on the compared result.

An authentication device being a node according to an aspect of the present invention comprises an authentication information input unit configured to receive authentication information; a current situation acquisition unit configured to receive, from a situation management device, a current situation of an operator and/or of an overall system including relevant systems connected thereto; and an allowed information generation unit configured to generate allowed information from the authentication information in accordance with the current situation to produce, as comparison information, the allowed information as it is or after converting the allowed information using a predetermined conversion function.

A comparison device being a node according to an aspect of the present invention comprises an authentication information acquisition unit configured to receive authentication information from an authentication device; a current situation acquisition unit configured to acquire, from a situation management device, a current situation of an operator and/or of an overall system including relevant systems connected thereto; a stored information acquisition unit configured to acquire registration information from a storage device; an information comparison unit configured to compare the authentication information with the registration information based on an acceptance range in accordance with the current situation to produce a compared result; and a result determination unit configure to determine an authenticated result based on the compared result.

An authentication method according to an aspect of the present invention comprises holding, in a situation management device, a current situation of an operator and/or of an overall system including relevant systems connected thereto; receiving, by a registration device, registration information to store, as stored information in a storage device, at least one of the registration information and information associated with the registration information as it is or after converting the at least one using a predetermined conversion function; receiving, by an authentication device, authentication information to produce, as comparison information, at least one of the authentication information and information associated with the authentication information as it is or after converting the last at least one using the predetermined conversion function; and comparing, by a comparison device, the stored information with the comparison information in accordance with the current situation.

A recording medium according to an aspect of the present invention has recorded thereon a program for causing a computer to execute processing of holding a current situation of an operator and/or of an overall system including relevant systems connected thereto; processing of receiving registration information and of storing, as stored information in a storage device, at least one of the registration information and information associated with the registration information as it is or after converting the at least one using a predetermined conversion function; processing of receiving authentication information and of producing, as comparison information, at least one of the authentication information and information associated with the authentication information as it is or after converting the last at least one using the predetermined conversion function; and processing of comparing the stored information with the comparison information in accordance with the current situation.

### Advantageous Effect of Invention

This invention has an advantageous effect that appropriate authentication of an operator can be carried out, taking into account a balance between usability and security, in accordance with a current situation of an operator and/or of an overall system including relevant systems connected thereto.

### BRIEF DESCRIPTION OF THE DRAWINGS

FIG. 1 is a block diagram for illustrating an example of configuration of an information processing system according to a first example embodiment of this invention.

FIG. 2 is a sequence chart for illustrating an example of operation relating to changing of a current situation of the information processing system according to the first example embodiment of this invention.

FIG. 3 is a sequence chart for illustrating an example of operation relating to registration of information in the information processing system according to the first example embodiment of this invention.

FIG. 4 is a sequence chart for illustrating an example of operation relating to authentication of information in the information processing system according to the first example embodiment of this invention.

FIG. 5 is a block diagram for illustrating an example of configuration of an information processing system according to a second example embodiment of this invention.

FIG. 6 is a sequence chart for illustrating an example of operation relating to registration of information in the information processing system according to the second example embodiment of this invention.

FIG. 7 is a sequence chart for illustrating an example of operation relating to authentication of information in the information processing system according to the second example embodiment of this invention.

FIG. 8 is a block diagram for illustrating an example of configuration of an information processing system according to a third example embodiment of this invention.

FIG. 9 is a sequence chart for illustrating an example of operation relating to authentication of information in the information processing system according to the third example embodiment of this invention.

FIG. 10 is a block diagram for illustrating a configuration of an information processing system according to another example embodiment of this invention or a node constituting the same.

### DESCRIPTION OF EMBODIMENTS

With reference to the drawings, modes for carrying out the invention will be described in detail. The respective drawings are intended to explain example embodiments of the present invention. However, the present invention is not limited to description of the respective drawings. In each figure and the description, similar parts are depicted by the same reference signs and the repeated description thereof may be omitted. In the drawings used in the following description, as regards configuration of any part which is not related to the description of the present invention, description thereof may be omitted and illustration may not be provided.

An authentication means used in a system of each example embodiment may be any means and is outside the scope of the present invention. For instance, examples of the authentication means include ID(identifier)/password authentication, authentication by a physical token, authentication by a smart card, biometric authentication, and so on.

### First Example Embodiment

[Description of Configuration]

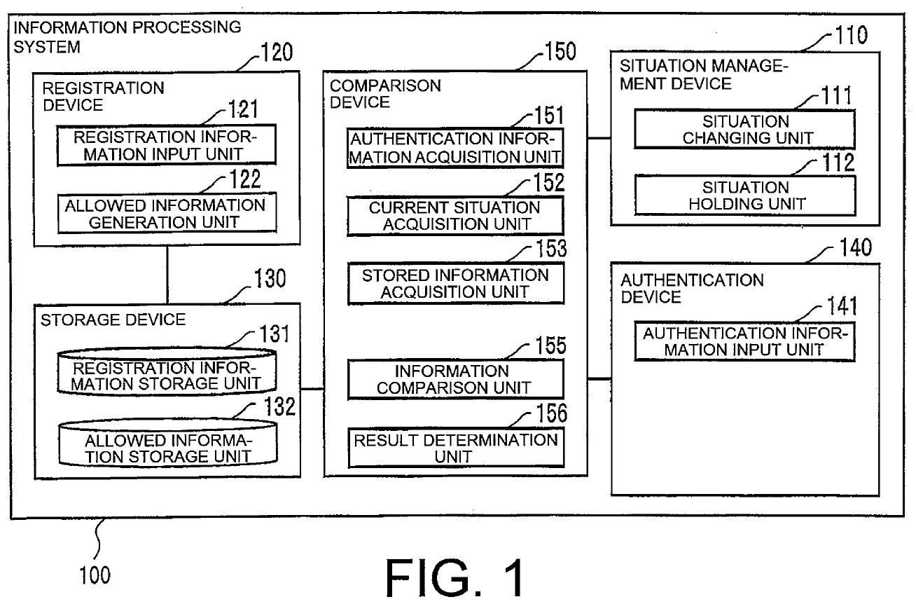

FIG. 1 is a block diagram for illustrating an example of configuration of an information processing system 100 according to a first example embodiment. As shown in FIG. 1, the information processing system 100 comprises a situation management device 110, a registration device 120, a storage device 130, an authentication device 140, and a comparison device 150. As shown in FIG. 1, the situation management device 110 is connected to the comparison device 150 via a predetermined communication channel (e.g. the Internet). The registration device 120 is connected to the storage device 130 via a predetermined communication channel. The storage device 130 is connected to the comparison device 150 via a predetermined communication channel. The authentication device 140 is connected to the comparison device 150 via a predetermined communication channel. The respective devices are not required to be mounted to different devices, respectively, and, for example, the authentication device 140 and the comparison device 150 may be mounted to the same apparatus.

The situation management device 110 comprises a situation changing unit 111 and a situation holding unit 112.

The registration device 120 comprises a registration information input unit 121 and an allowed information generation unit 122.

The storage device 130 comprises a registration information storage unit 131 and an allowed information storage unit 132.

The authentication device 140 comprises an authentication information input unit 141.

The comparison device 150 comprises an authentication information acquisition unit 151, a current situation acquisition unit 152, a stored information acquisition unit 153, an information comparison unit 155, and a result determination unit 156.

[Description of Operation]

Next, referring to the drawings, operation of the whole of the first example embodiment will be described in detail.

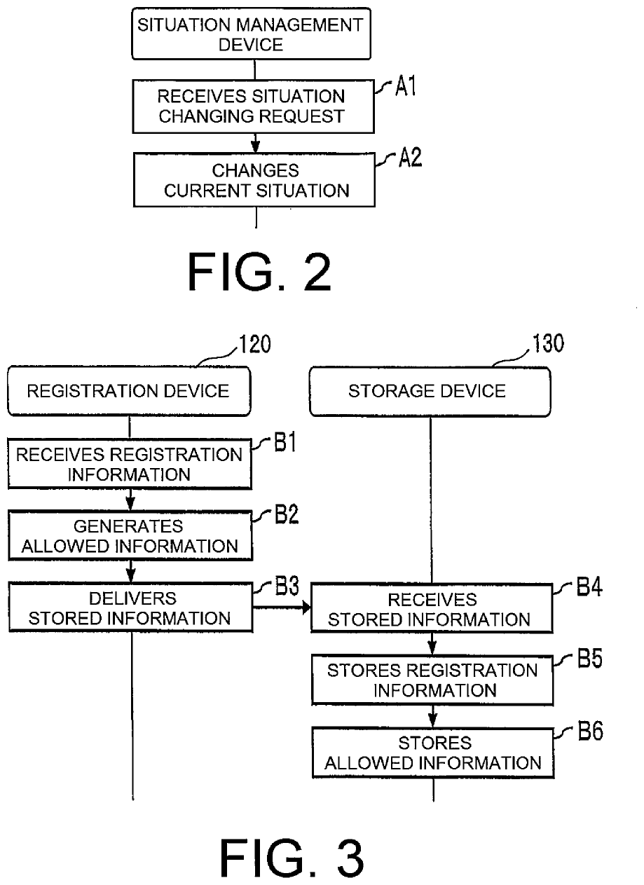

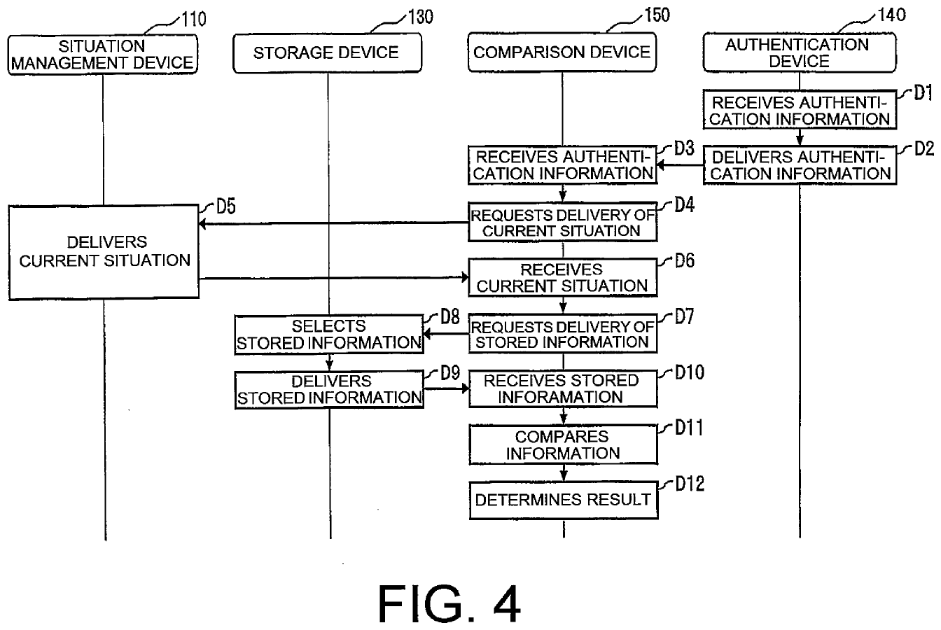

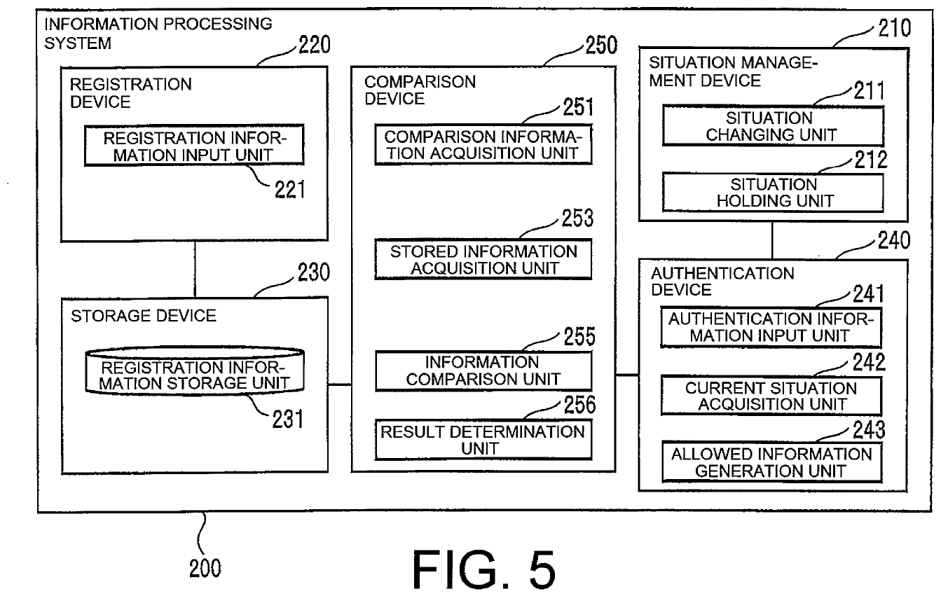

FIG. 2 is a sequence chart for illustrating an example of operation relating to changing of a current situation of the information processing system 100 illustrated in FIG. 1. FIG. 3 is a sequence chart for illustrating an example of operation relating to changing of a current situation in the information processing system 100 illustrated in FIG. 1. FIG. 4 is a sequence chart for illustrating an example of operation relating to authentication in the information processing system 100 illustrated in FIG. 1. First, operation of the whole of the information processing system 100 according to the first example embodiment will be described.

Upon executing the information processing system 100 according to the first example embodiment, the situation management device 110 is set with a current situation of an operator and/or of an overall system including relevant systems connected thereto. The current situation is changed in accordance with a situation. In the description, the “overall system” means not only the information processing system 100 and an operator operating the information processing system 100 but also relevant systems, such as a control system connected to the information processing system 100, and so on. Accordingly, the overall system means an environment surrounding the information processing system 100. For instance, the current situation is changed in accordance with a fault of any apparatus in the information processing system 100 and the relevant systems, a disaster occurring at a position where the information processing system 100 and the relevant systems are located, and a cybersecurity incident occurring in the information processing system 100 and the relevant systems. In addition, for example, the current situation is changed in accordance with a current mental condition of the operator (e.g. degree of stress) and a physical condition (e.g. degree of contamination of the skin).

The registration device 120 of the information processing system 100 according to the first example embodiment is supplied with information to be registered (which will be called “registration information” hereinafter). The registration device 120 calculates, based on the supplied registration information, authentication information to be accepted in each situation (which will be called “allowed information” hereinafter). The registration information and the allowed information are delivered to the storage device 130 and are stored in the storage device 130 as stored information. The allowed information is information associated with the registration information.

The authentication device 140 of the information processing system 100 according to the first example embodiment is supplied with information used in authentication (which will be called “authentication information” hereinafter). The authentication information is delivered to the comparison device 150 as comparison information. The comparison device 150 refers to the current situation set in the situation management device 110 and acquires, from the storage device 130, information in accordance therewith (which will be called “stored information” hereinafter). Furthermore, the comparison device 150 compares the authentication information (comparison information) with the stored information, and determines and produces an authenticated result.

Hereinafter, respective operations of the information processing system 100 according to the first example embodiment will be described in detail with reference to the drawings.

[Operation Relating to Changing of Current Situation]

Referring to FIG. 2, description will proceed to processing performed by the information processing system 100 according to the first example embodiment upon changing the current situation of the overall system. FIG. 2 is a flow chart for illustrating an example of the processing performed by the information processing system 100 according to the first example embodiment upon changing the current situation of the overall system.

The situation changing unit 111 of the situation management device 110 receives a situation changing request (Step A1). Herein, in the situation changing request, a current situation after changing is explicitly shown. Based on the current situation after changing, the situation changing unit 111 changes the current situation of the overall system which is held in the situation holding unit 112 of the situation management device 110 (Step A2).

In the situation management device 110 according to the first example embodiment, the situation changing unit 111 may change the current situation of the overall system based on any judgment, and what judgment is used to change the current situation of the overall system is outside the scope of the present invention. For instance, when a sensor such as a seismometer detects abnormality (such as occurrence of an earthquake), the situation changing unit 111 may change the current situation of the overall system. For instance, when an intruder or intrusion of malware or the like is detected, the situation changing unit 111 may change the current situation of the overall system. For instance, when a fault or disconnection of an apparatus included in a system to be controlled is detected, the situation changing unit 111 may change the current situation of the overall system. For instance, the situation changing unit 111 may change the current situation of the overall system in accordance with a situation changing command supplied by an administrator. In addition, kinds of the current situation are outside the scope of the present invention. For instance, the current situation may include two kinds of situations, i.e., a normal situation and an abnormal situation. For instance, the current situation may be classified into three or more kinds, such as the normal situation, a slight abnormal situation, and a serious abnormal situation.

[Operation Relating to Registration]

Referring to FIG. 3, description will proceed to processing performed by the information processing system 100 according to the first example embodiment upon registering information. FIG. 3 is a flow chart for illustrating an example of the processing performed by the information processing system 100 according to the first example embodiment upon registering the information.

The registration device 120 is supplied with the registration information. The registration information input unit 121 receives the supplied registration information (Step B1). The allowed information generation unit 122 generates one type or a plurality of types of allowed information based on the registration information (Step B2). For instance, the allowed information generation unit 122 may generate pieces of the allowed information which conform in number with the situations to be held in the situation holding unit 112 of the situation management device 110. The registration device 120 merges, as the stored information the registration information and the allowed information, and delivers the stored information to the storage device 130 (Step B3). However, the registration device 120 may transform (convert) the registration information and the allowed information (stored information) into different converted stored information using a hash function or the like and then deliver the converted stored information to the storage device 130. Herein, the “hash function” is a function of converting data having an arbitrary length into data having a fixed length (hash value). Furthermore, other conversion functions than the hash function may be used. Accordingly, in this event, the registration device 120 delivers, to the storage device 130, the converted stored information instead of the stored information.

The storage device 130 receives the stored information from the registration device 120 (Step B4). Herein, it is assumed that the stored information is not the converted stored information. The storage device 130 stores the registration information of the stored information in the registration information storage unit 131 (Step B5) and stores the allowed information of the stored information in the allowed information storage unit 132 (Step B6). However, in a manner similar to that mentioned above, the storage device 130 may transform (convert) the registration information and the allowed information into the above-mentioned different converted stored information using the hash function or the like and then store the converted stored information (in this example, the hash value) in the registration information storage unit 131 and the allowed information storage unit 132.

[Operation Relating to Authentication]

Referring to FIG. 4, description will proceed to processing performed by the information processing system 100 according to the first example embodiment upon authenticating information. FIG. 4 is a flow chart for illustrating an example of the processing performed by the information processing system 100 according to the first example embodiment upon authenticating the information.

The authentication device 140 is supplied with authentication information. The authentication information input unit 141 receives the supplied authentication information (Step D1). The authentication device 140 delivers the authentication information as comparison information to the comparison device 150 (Step D2). However, the authentication device 140 may transform (convert) the authentication information (comparison information) into different authentication information using a conversion function such as the hash function and then deliver the converted authentication information to the comparison device 150.

The authentication information acquisition unit 151 of the comparison device 150 receives the authentication information (comparison information) from the authentication device 140 (Step D3). The current situation acquisition unit 152 requests the situation management device 110 to deliver the current situation of the overall system (Step D4), and the situation management device 110 delivers the current situation of the overall system to the comparison device 150 (Step D5). The current situation acquisition unit 152 of the comparison device 150 receives the current situation of the overall system from the situation management device 110 (Step D6).

The stored information acquisition unit 153 of the comparison device 150 requests the storage device 130 to deliver the authentication information received in the Step D3 and stored information in accordance with the current situation which has been received in the Step D6 (Step D7). For instance, when an ID is included in the authentication information, the stored information acquisition unit 153 may request delivery of only the stored information corresponding to the ID. For instance, when the current situation is “normality”, the stored information acquisition unit 153 may request delivery of the registration information. When the current situation of the overall system is “slight abnormality”, the stored information acquisition unit 153 may request delivery of the allowed information in accordance with the “slight abnormality”. When the current situation of the overall system is “serious abnormality”, the stored information acquisition unit 153 may request delivery of the allowed information in accordance with the “serious abnormality”. The storage device 130 selects the stored information in accordance with a request from the comparison device 150 (Step D8) and then delivers the selected stored information to the comparison device 150 (Step D9).

The stored information acquisition unit 153 of the comparison device 150 receives the selected stored information from the storage device 130 (Step D10). The information comparison unit 155 compares the authentication information received in the Step D3 with the stored information received in the Step D10 (Step D11). Herein, as described above, the stored information may be the converted stored information whereas the authentication information also may be the converted authentication information. In this event, the information comparison unit 155 compares the converted authentication information with the converted stored information.

The result determination unit 156 of the comparison device 150 determines an authenticated result based on a compared result in the Step D11 (Step D12). In other words, the result determination unit 156 decides an authentication level of the operator based on the compared result. The authenticated result (authentication level) may be delivered from the comparison device 150 to the authentication device 140. For example, the authentication device 140 may display the authenticated result (authentication level) on a display or the like. In addition, for example, the authentication device 140 may give a user an access authority having an intensity and a scope in accordance with the current situation of the overall system or the authenticated result (authentication level).

However, it is not necessary for the result determination unit 156 of the comparison device 150 to determine the authenticated result (authentication level) based on only one compared result. For instance, the result determination unit 156 may repeat the Steps D1 to D3 and the Step D11 a plurality of number of times and then accept in a case where the comparison is successful at least the number of times in accordance with the current situation of the overall system, and not accept otherwise.

[Description of Effect]

An effect in the first example embodiment described above is that authentication is possible at the intensity in accordance with the current situation of the operator and/or of the overall system including the relevant systems connected thereto. This is because the following configuration is included. Specifically, the registration device 120 generates, based on the supplied registration information, the allowed information being the authentication information to be accepted in each situation and stores it in the storage device 130. Then, the comparison device 150 compares the authentication information supplied to the authentication device 140 and the stored information (registration information or allowed information) selected in accordance with the current situation of the operator and/or of the overall system including the relevant systems connected thereto to determine the authenticated result.

### Second Example Embodiment

[Description of Configuration]

FIG. 5 is a block diagram for illustrating an example of configuration of an information processing system 200 according to a second example embodiment. As shown in FIG. 5, the information processing system 200 comprises a situation management device 210, a registration device 220, a storage device 230, an authentication device 240, and a comparison device 250. As shown in FIG. 5, the situation management device 210 is connected to the authentication device 240 via a predetermined communication channel (e.g. the Internet). The registration device 220 is connected to the storage device 230 via a predetermined communication channel. The storage device 230 is connected to the comparison device 250 via a predetermined communication channel. The authentication device 240 is connected to the comparison device 250 via a predetermined communication channel. The respective devices are not required to be mounted to different devices, respectively, and, for example, the authentication device 240 and the comparison device 250 may be mounted to the same apparatus.

The situation management device 210 comprises a situation changing unit 211 and a situation holding unit 212.

The registration device 220 comprises a registration information input unit 221.

The storage device 230 comprises a registration information storage unit 231.

The authentication device 240 comprises an authentication information input unit 241, a current situation acquisition unit 242, and an allowed information generation unit 243.

The comparison device 250 comprises a comparison information acquisition unit 251, a stored information acquisition unit 253, an information comparison unit 255, and a result determination unit 256.

[Description of Operation]

Next, referring to the drawings, operation of the whole of the second example embodiment will be described in detail.

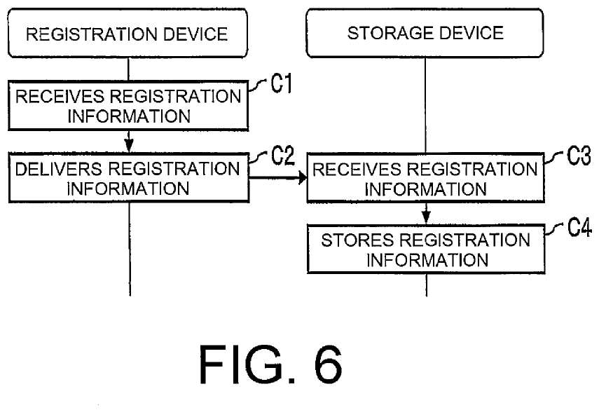

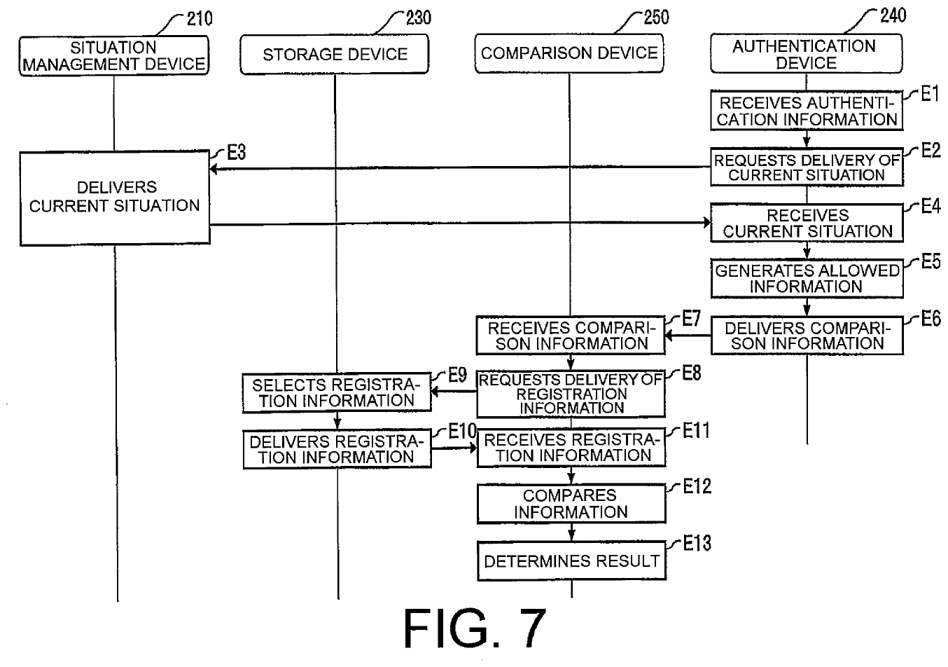

FIG. 6 is a sequence chart for illustrating an example of operation relating to registration of information in the information processing system 200 illustrated in FIG. 5. FIG. 7 is a sequence chart for illustrating an example of operation relating to authentication in the information processing system 200 illustrated in FIG. 5. First, operation of the whole of the information processing system 200 according to the second example embodiment will be described.

Upon executing the information processing system 200 according to the second example embodiment, the situation management device 210 is set with a current situation of the overall system. The current situation is changed in accordance with a situation.

The registration device 220 of the information processing system 200 according to the second example embodiment is supplied with information to be registered (which will be called “registration information” hereinafter). The registration information is delivered to the storage device 230 and is stored in the storage device 230 as stored information.

The authentication device 240 of the information processing system 200 according to the second example embodiment is supplied with information used in authentication (which will be called “authentication information” hereinafter). Furthermore, the authentication device 240 acquires the current situation of the overall system by inquiring at the situation management device 210 to generate allowed information in accordance with the current situation. Furthermore, the authentication device 240 delivers, to the comparison device 250, the generated allowed information as information in accordance with the current situation of the overall system (which will be called “comparison information” hereinafter). The comparison device 250 acquires the registration information from the storage device 230, compares the registration information with the comparison information, and determines and produces an authenticated result.

Hereinafter, respective operations of the information processing system 200 according to the second example embodiment will be described in detail with reference to the drawings.

[Operation Relating to Changing of Current Situation]

Processing performed by the information processing system 200 according to the second example embodiment upon changing the current situation of the overall system is similar to the processing (FIG. 2) performed by the information processing system 100 according to the first example embodiment upon changing the current situation of the overall system.

As shown in FIG. 2, the situation changing unit 211 of the situation management device 210 receives a situation changing request (Step A1). Herein, in the situation changing request, a current situation after changing is explicitly shown. Based on the current situation after changing, the situation changing unit 211 changes the current situation of the overall system which is held in the situation holding unit 212 of the situation management device 210 (Step A2).

In the situation management device 210 according to the second example embodiment, the situation changing unit 211 may change the current situation of the overall system based on any judgment, and what judgment is used to change the current situation of the overall system is outside the scope of the present invention. For instance, when a sensor such as a seismometer detects abnormality (such as occurrence of an earthquake), the situation changing unit 211 may change the current situation of the overall system. For instance, when an intruder or intrusion of malware is detected, the situation changing unit 211 may change the current situation of the overall system. For instance, when a fault or disconnection of an apparatus included in a system to be controlled is detected, the situation changing unit 211 may change the current situation of the overall system. For instance, the situation changing unit 211 may change the current situation of the overall system in accordance with a situation changing command supplied by an administrator. In addition, kinds of the current situation are outside the scope of the present invention. For instance, the current situation may include two kinds of situations, i.e., a normal situation and an abnormal situation. For instance, the current situation may be classified into three or more kinds, such as the normal situation, a slight abnormal situation, and a serious abnormal situation.

[Operation Relating to Registration]

Referring to FIG. 6, description will proceed to processing performed by the information processing system 200 according to the second example embodiment upon registering information. FIG. 6 is a flow chart for illustrating an example of the processing performed by the information processing system 200 according to the second example embodiment upon registering the information.

The registration device 220 is supplied with the registration information. The registration information input unit 221 receives the supplied registration information (Step C1). The registration device 220 delivers the acquired registration information to the storage device 230 (Step C2). However, the registration device 220 may transform (convert) the registration information into different converted registration information using a conversion function such as a hash function and then deliver the converted registration information to the storage device 230.

The storage device 230 receives the registration information from the registration device 220 (Step C3) and stores the registration information in the registration information storage unit 231 as stored information (Step C4). Herein, it is assumed that the registration information (stored information) is not the converted registration information (converted stored information). However, the storage device 230 may transform (convert) the registration information (stored information) into the different converted registration information (converted stored information) using the conversion function such as the hash function and then store the converted registration information (converted stored information) in the registration information storage unit 231.

[Operation Relating to Authentication]

Referring to FIG. 7, description will proceed to processing performed by the information processing system 200 according to the second example embodiment upon authenticating information. FIG. 7 is a flow chart for illustrating an example of the processing performed by the information processing system 200 according to the second example embodiment upon authenticating the information.

The authentication device 240 is supplied with authentication information. The authentication information input unit 241 receives the supplied authentication information (Step E1). The current situation acquisition unit 242 requests the situation management device 210 to deliver the current situation of the overall system (Step E2), and the situation management device 210 delivers the current situation of the overall system to the authentication device 240 (Step E3). The current situation acquisition unit 242 of the authentication device 24 receives the current situation of the overall system from the situation management device 210 (Step E4).

The allowed information generation unit 243 of the authentication device 240 generates, in accordance with the current situation of the overall system which has been received in the Step E4, allowed information based on the authentication information acquired in the Step E1 (Step E5). However, the allowed information generation unit 243 may not generate the allowed information depending on the current situation of the overall system. For instance, when the current situation of the overall system is “normality”, authentication may be carried out using the authentication information itself without using the allowed information. Accordingly, in this case, the allowed information generation unit 243 treats the authentication information as it is as the allowed information. The authentication device 240 delivers at least one of the allowed information or the authentication information as comparison information to the comparison device 250 (Step E6). It is noted that the comparison information refers to the allowed information when the allowed information is generated in the Step E5 and refers to the authentication information when the allowed information is not generated in the Step E5. The authentication device 240 may transform (convert) the comparison information into different converted comparison information using the conversion function such as the hash function and then deliver the converted comparison information to the comparison device 250.

The comparison information acquisition unit 251 of the comparison device 250 receives the comparison information from the authentication device 240 (Step E7). Herein, it is assumed that the comparison information is not the converted comparison information. The stored information acquisition unit 253 requests the storage device 230 to deliver the registration information in accordance with the received comparison information (Step E8). For instance, when an ID is included in the authentication information, the stored information acquisition unit 253 may request delivery of only the registration information corresponding to the ID. The storage device 230 selects the registration information in accordance with a request from the comparison device 250 (Step E9) and then delivers the selected registration information to the comparison device 250 (Step E10).

The information comparison unit 255 of the comparison device 250 compares the comparison information received in the Step E7 with the registration information received in the Step E11 (Step E12). Herein, as described above, the registration information may be the converted registration information whereas the comparison information also may be the converted comparison information. In this event, the information comparison unit 255 compares the converted comparison information with the converted registration information.

The result determination unit 256 of the comparison device 250 determines an authenticated result based on a compared result in the Step E12 (Step E13). In other words, the result determination unit 256 decides an authentication level of the operator based on the compared result. The authenticated result may be delivered from the comparison device 250 to the authentication device 240. For example, the authentication device 240 may display the authenticated result (authentication level) on a display or the like. In addition, for example, the authentication device 240 may give a user an access authority having an intensity and a scope in accordance with the current situation of the overall system including the operator or the authenticated result (authentication level).

However, it is not necessary for the result determination unit 256 of the comparison device 250 to determine the authenticated result (authentication level) based on only one compared result. For instance, the result determination unit 256 may repeat the Steps E7 to E12 a plurality of number of times and then accept in a case where the comparison is successful at least the number of times in accordance with the current situation of the operator and/or of the overall system including the relevant systems, and not accept otherwise.

[Description of Effect]

An effect in the second example embodiment described above is that authentication is possible at the intensity in accordance with the current situation of the operator and/or of the overall system including the relevant systems connected thereto. This is because the following configuration is included. Specifically, the registration information supplied to the registration device 220 is stored in the storage device 230, and the authentication device 240 generates, in accordance with the current situation of the operator and/or of the overall system including the relevant systems connected thereto, the allowed information, which is the authentication information possibly accepted in the current situation, based on the supplied authentication information, and delivers the allowed information as the comparison information to the comparison device 250. Then, the comparison device 250 compares the comparison information delivered from the authentication device 240 with the registration information stored in the storage device 230 to determine the authenticated result.

### Third Example Embodiment

[Description of Configuration]

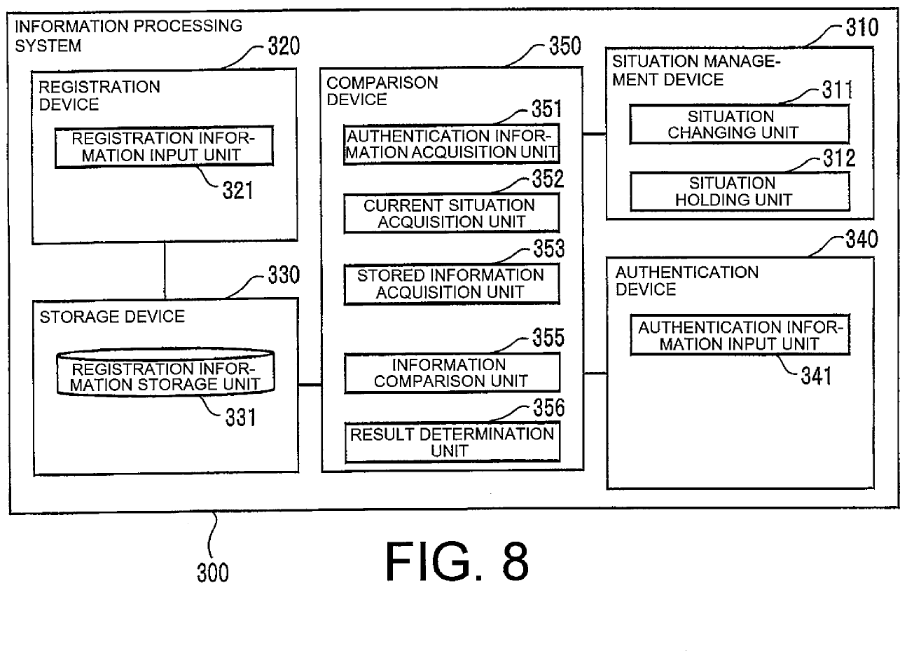

FIG. 8 is a block diagram for illustrating an example of configuration of an information processing system 300 according to a third example embodiment. As shown in FIG. 8, the information processing system 300 comprises a situation management device 310, a registration device 320, a storage device 330, an authentication device 340, and a comparison device 350. As shown in FIG. 8, the situation management device 310 is connected to the comparison device 350 via a predetermined communication channel (e.g. the Internet). The registration device 320 is connected to the storage device 330 via a predetermined communication channel. The storage device 330 is connected to the comparison device 350 via a predetermined communication channel. The authentication device 340 is connected to the comparison device 350 via a predetermined communication channel. The respective devices are not required to be mounted to different devices, respectively, for example, the authentication device 340 and the comparison device 350 may be mounted to the same apparatus.

The situation management device 310 comprises a situation changing unit 311 and a situation holding unit 312.

The registration device 320 comprises a registration information input unit 321.

The storage device 330 comprises a registration information storage unit 331.

The authentication device 340 comprises an authentication information input unit 341.

The comparison device 350 comprises an authentication information acquisition unit 351, a current situation acquisition unit 352, a stored information acquisition unit 353, an information comparison unit 355, and a result determination unit 356.

[Description of Operation]

Next, referring to the drawings, operation of the whole of this example embodiment will be described in detail.

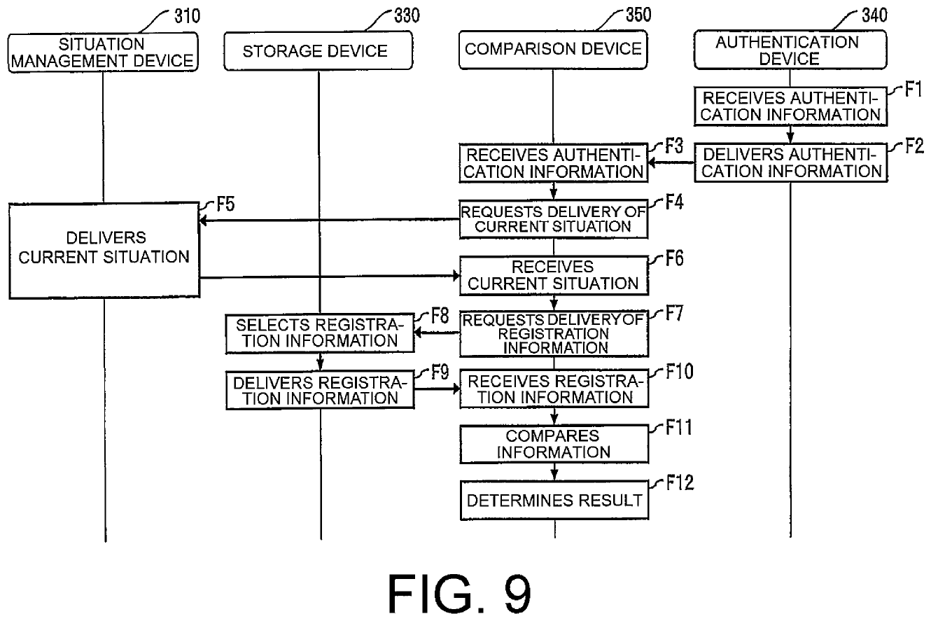

FIG. 9 is a sequence chart for illustrating an example of operation relating to authentication of information in the information processing system 300 according to the third example embodiment. First, operation of the whole of the information processing system 300 according to the third example embodiment will be described.

Upon executing the information processing system 300 according to the third example embodiment, the situation management device 310 is set with a current situation of the overall system. The current situation is changed in accordance with a situation.

The registration device 320 of the information processing system 300 according to the third example embodiment is supplied with information to be registered (which will be called “registration information” hereinafter). The registration information is delivered to the storage device 330 and is stored in the storage device 330 as stored information.

The authentication device 340 of the information processing system 300 according to the third example embodiment is supplied with information used in authentication (which will be called “authentication information” hereinafter). The authentication information is delivered to the comparison device 350 as comparison information. The comparison device 350 acquires a current situation of the overall system, which is set in the situation management device 310, and the registration information stored in the storage device 330. Furthermore, the comparison device 350 compares, in accordance with the acquired current situation, the authentication information with the stored information, and determines and produces an authenticated result.

Hereinafter, respective operations of the information processing system 300 according to the third example embodiment will be described in detail with reference to the drawings.

[Operation Relating to Changing of Current Situation]

Processing performed by the information processing system 300 according to the third example embodiment upon changing the current situation of the overall system is similar to the processing (FIG. 2) performed by the information processing system 100 according to the first example embodiment upon changing the current situation of the overall system.

As shown in FIG. 2, the situation changing unit 311 of the situation management device 310 receives a situation changing request (Step A1). Herein, in the situation changing request, a current situation after changing is explicitly shown. Based on the current situation after changing, the situation changing unit 311 changes the current situation of the overall system which is held in the situation holding unit 312 of the situation management device 310 (Step A2).

In the situation management device 310 according to the third example embodiment, the situation changing unit 311 may change the current situation of the overall system based on any judgment, and what judgment is used to change the current situation of the overall system is outside the scope of the present invention. For instance, when a sensor such as a seismometer detects abnormality (such as occurrence of an earthquake), the situation changing unit 311 may change the current situation of the overall system. For instance, when an intruder or intrusion of malware is detected, the situation changing unit 311 may change the current situation of the overall system. For instance, when a fault or disconnection of an apparatus included in a system to be controlled is detected, the situation changing unit 311 may change the current situation of the overall system. For instance, the situation changing unit 311 may change the current situation of the overall system in accordance with a situation changing command supplied by an administrator. In addition, kinds of the current situation are outside the scope of the present invention. For instance, the current situation may include two kinds of situations, i.e., a normal situation and an abnormal situation. For instance, the current situation may be classified into three or more kinds, such as the normal situation, a slight abnormal situation, and a serious abnormal situation.

[Operation Relating to Registration]

Processing performed by the information processing system 300 according to the third example embodiment upon registering information is similar to the processing (FIG. 6) performed by the information processing system 200 according to the second example embodiment upon registering the information.

As shown in FIG. 6, the registration device 320 is supplied with the registration information. The registration information input unit 321 receives the supplied registration information (Step C1). The registration device 320 delivers the acquired registration information to the storage device 230 (Step C2). However, the registration device 320 may transform (convert) the registration information into different converted registration information using a conversion function such as a hash function and then deliver the converted registration information to the storage device 330.

The storage device 330 receives the registration information from the registration device 320 (Step C3) and stores the registration information in the registration information storage unit 331 as stored information (Step C4). Herein, it is assumed that the registration information is not the converted registration information. However, the storage device 330 may transform (convert) the registration information (stored information) into the different converted registration information (converted stored information) using the conversion function such as the hash function and then store the converted registration information (converted stored information) in the registration information storage unit 331.

[Operation Relating to Authentication]

Referring to FIG. 9, description will proceed to processing performed by the information processing system 300 according to the third example embodiment upon authenticating information. FIG. 9 is a flow chart for illustrating an example of the processing performed by the information processing system 300 according to the third example embodiment upon authenticating the information.

The authentication device 340 is supplied with authentication information. The authentication information input unit 341 receives the supplied authentication information (Step F1) and delivers the authentication information as comparison information to the comparison device 350 (Step F2). However, the authentication device 340 may transform (convert) the authentication information into different authentication information using the conversion function such as the hash function and then deliver the converted authentication information to the comparison device 350.

The authentication information acquisition unit 351 of the comparison device 350 receives the authentication information from the authentication device 340 (Step F3). Herein, it is assumed that the authentication information is not the converted authentication information. The current situation acquisition unit 342 requests the situation management device 310 to deliver the current situation of the overall system (Step F4), and the situation management device 310 delivers the current situation of the overall system to the comparison device 350 (Step F5). The current situation acquisition unit 352 of the comparison device 350 receives the current situation of the overall system from the situation management device 310 (Step F6).

The stored information acquisition unit 353 of the comparison device 350 requests the storage device 330 to deliver the registration information in accordance with the received authentication information (Step F7). For instance, when an ID is included in the authentication information, the stored information acquisition unit 353 may request delivery of only the registration information corresponding to the ID. The storage device 330 selects the registration information in accordance with a request from the comparison device 350 (Step F8) and then delivers the selected registration information to the comparison device 350 (Step F9).

The information comparison unit 355 of the comparison device 350 compares the authentication information received in the Step F3 with the registration information received in the Step F8 based on an acceptance range in accordance with the current situation of the overall system which is received in the Step F6 (Step F11). For instance, when the current situation of the overall system is “normality”, the information comparison unit 355 confirms identity between the registration information and the authentication information. On the other hand, when the current situation of the overall system is “abnormality”, the information comparison unit 355 may compare the registration information with the authentication information with appropriate ambiguity permitted. Herein, as described above, the registration information may be the converted registration information whereas the authentication information also may be the converted authentication information. In this event, the information comparison unit 355 compares the converted registration information with the converted authentication information based on the acceptance range in accordance with the current situation.

The result determination unit 356 determines an authenticated result based on a compared result in the Step F11 (Step F12). In other words, the result determination 356 decides an authentication level of the operator based on the current situation or the compared result. The authenticated result (authentication level) may be delivered from the comparison device 350 to the authentication device 340. For example, the authentication device 240 may display the authenticated result (authentication level) on a display or the like. In addition, for example, the authentication device 240 may give a user an access authority having an intensity and a scope in accordance with the current situation of the overall system including the operator or the authenticated result (authentication level).

However, it is not necessary for the result determination unit 356 of the comparison device 350 to determine the authenticated result (authentication level) based on only one compared result. For instance, the result determination unit 356 may repeat the Steps F1 to F3 and the Step F11 a plurality of number of times and then accept in a case where the comparison is successful at least the number of times in accordance with the current situation of the overall system including the operator, and not accept otherwise.

[Description of Effect]

An effect in the third example embodiment described above is that authentication is possible at the intensity in accordance with the current situation of the operator and/or of the overall system including the relevant systems connected thereto. This is because the following configuration is included. Specifically, the registration information supplied to the registration device 320 is stored in the storage device 330, and the comparison device 350 compares the registration information stored in the storage device 330 with the authentication information supplied to the authentication device 340 based on the acceptance range in accordance with the current situation of the operator and/or of the overall system including the relevant systems connected thereto, that is held in the situation management device 310, to determine the authenticated result.

### Examples

An authentication means used in a system of each example embodiment may be any means. For instance, examples of the authentication means include ID/password authentication, authentication by a physical token, authentication by a smart card, biometric authentication, and so on.

For example, when the ID/password authentication is used as the authentication means 140 in the information processing system 100 of the first example embodiment, the following operation is supposed as one example thereof. The registration information acquired in the Step B1 includes the ID and the password. In the Step B2, an allowed password is generated from the password acquired in the Step B1. The allowed password may be, for example, a password which is easily entered by an input error on inputting the registered password. When the ID is stored in the storage device 130, for the ID and the password, which are supplied to the authentication device 140 and delivered to the authentication information acquisition unit 151 of the comparison device 150, the stored information acquisition unit 153 of the comparison device 150 may acquire, from the stored information stored in the storage device 130, the stored information corresponding to the acquired ID. In this event, the information comparison unit 155 compares those passwords associated with the same ID.

For example, when the biometric authentication is used as the authentication means 140 in the information processing system 100 of the first example embodiment, the following operation will be supposed as the one example thereof. The registration information acquired in the Step B1 includes biometric information of the operator. In the Step B2, allowed biometric information is generated from the biometric information acquired in the Step B1. The allowed biometric information may be, for example, the biometric information which is easily entered on inputting the authentication information with contamination or the like adhered to a living body which is the same as that on registration.

The same also applies to the second example embodiment and the third example embodiment, like in the first example embodiment.

### Other Example Embodiments

Each of the information processing system and the situation management device, the registration device, the authentication device, and the comparison device constituting the information processing system may be implemented by hardware or may be implemented by software. In addition, each of the information processing system and the situation management device, the registration device, the authentication device, and the comparison device constituting the information processing system may be implemented by a combination of hardware and software.

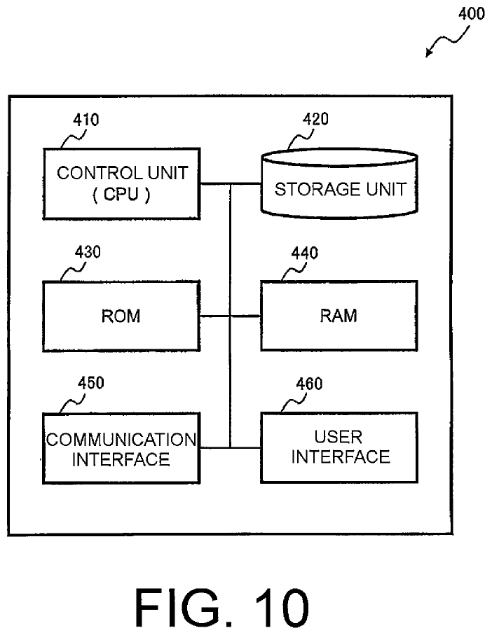

FIG. 10 is a block diagram for illustrating one example of an information processing apparatus (computer) constituting each of the information processing system and the situation management device, the registration device, the authentication device, and the comparison device constituting the information processing system.

As shown in FIG. 10, the information processing apparatus 400 comprises a control unit (CPU: Central Processing Unit) 410, a storage unit 420, an ROM (Read Only Memory) 430, an RAM (Random Access Memory) 440, a communication interface 450, and a user interface 460.

The control unit (CPU) 410 may implement various functions of each of the information processing system and the situation management device, the registration device, the authentication device, and the comparison device constituting the information proccing system by developing and executing, in the RAM 440, a program held in the storage unit 420 or the ROM 430. In addition, the control unit (CPU) 410 may comprise an internal buffer which is adapted to temporarily store data or the like.

The storage unit 420 comprises a large-capacity storage medium which can hold various types of data and may be implemented by a storage medium such as an HDD (Hard Disk Drive), an SSD (Solid State Drive), and so on. The storage unit 420 may be a cloud storage existing in a communication network when the information processing apparatus 400 is connected to the communication network via the communication interface 450. The storage unit 420 may hold the program readable by the control unit (CPU) 410.

The ROM 430 comprises a nonvolatile storage device which may be constituted by a flash memory having a small capacity as compared to the storage unit 420. The ROM 430 may hold a program which is readable by the control unit (CPU) 410. The program readable by the control unit (CPU) 410 may be held in at least one of the storage unit 420 and the ROM 430.

The program readable by the control unit (CPU) 410 may be supplied to the information processing apparatus 400 in a state where it is non-transitorily stored in various storage media readable by the computer. Such storage media may be, for example, a magnetic tape, a magnetic disk, a magneto-optical disc, a CD-ROM (compact disc read only memory), a CD-R (compact disc-recordable), a CD-R/W (compact disc-rewritable), and a semiconductor memory.

The RAM 440 comprises a semiconductor memory such as a DRAM (Dynamic Random Access Memory) and an SRAM (Static Random Access Memory) and may be used as an internal buffer which temporarily stores data and so on.

The communication interface 450 is an interface which connects the information processing apparatus 400 and the communication network via wire or wirelessly.

The user interface 460 comprises, for example, a displaying unit such as a display and an input unit such as a keyboard, a mouse, and a touch panel.

While the present invention has been described with reference to example embodiments and examples thereof, the present invention is not limited to the above-mentioned example embodiments and examples. The present invention also includes a mode obtained by appropriately combining a part or a whole of the example embodiments and any mode obtained by suitably modifying the above-mentioned mode.

The whole or part of the example embodiments described above can be described as, but not limited to, in the following supplementary notes.

(Supplementary Note 1)

An information processing system, including:

a situation management device configured to hold a current situation of an operator and/or of an overall system including relevant systems connected thereto;

a registration device configured to: receive registration information; and to store, as stored information in a storage device, at least one of the registration information and information associated with the registration information as it is or after converting the at least one using a predetermined conversion function;

an authentication device configured to: receive authentication information; and to produce, as comparison information, at least one of the authentication information and information associated with the authentication information as it is or after converting the last at least one using the predetermined conversion function; and

a comparison device configured to compare the stored information with the comparison information in accordance with the current situation.

(Supplementary Note 2)

The information processing system according to Supplementary Note 1,

wherein the registration device includes: a registration information input unit configured to receive the registration information; and an allowed information generation unit configured to generate allowed information as the information associated with the registration information, the registration device being configured to deliver, as the stored information to the storage device, a combination of the registration information and the allowed information as it is or after converting the combination using the predetermined conversion function,

wherein the storage device comprises: a registration information storage unit configured to store the registration information as a part of the stored information; and an allowed information storage unit configured to store the allowed information as a different part of the stored information,

wherein the authentication device includes an authentication information input unit configured to receive the authentication information, the authentication device being configured to deliver, as the comparison information to the comparison device, the authentication information as it is or after converting the authentication information using the predetermined conversion function, and

wherein the comparison device includes: a stored information acquisition unit configured to selectively receive the stored information stored in the storage device in accordance with the current situation; and an information comparison unit configured to compare the selected stored information with the authentication information.

(Supplementary Note 3)

The information processing system according to Supplementary Note 1,

wherein the registration device includes a registration information input unit configured to receive the registration information, the registration device being configured to deliver, as the stored information to the storage device, the registration information as it is or after converting the registration information using the predetermined conversion function,

wherein the authentication device includes: an authentication information input unit configured to receive the authentication information; a current situation acquisition unit configured to receive the current situation from the situation management device; and an allowed information generation unit configured to generate allowed information as the information associated with the authentication information based on a judgement in accordance with the current situation, the authentication device being configured to deliver, as the comparison information to the comparison device, at least one of the allowed information and the authentication information as it is or after converting the at least one using the predetermined conversion function, and

wherein the comparison device includes an information comparison unit configured to compare the registration information received from the storage device with the comparison information received from the authentication device.

(Supplementary Note 4)

The information processing system according to Supplementary Note 1,

wherein the registration device includes a registration information input unit configured to receive the registration information, the registration device being configured to deliver, as the stored information to the storage device, the registration information as it is or after converting the registration information using the predetermined conversion function,

wherein the authentication device includes an authentication information input unit configured to receive the authentication information, the authentication device being configured to deliver, as the comparison information to the comparison device, the authentication information as it is or after converting the authentication information using the predetermined conversion function, and

wherein the comparison device includes: a current situation acquisition unit configured to receive the current situation from the situation management device; and an information comparison unit configured to compare the registration information and the authentication information based on an acceptance range in accordance with the current situation.

(Supplementary Note 5)

The information processing system according to any one of Supplementary Notes 1 to 4, wherein the comparison device includes a result determination unit configured to determine an authentication level of the operator based on the current situation or a compared result of the information comparison unit.

(Supplementary Note 6)

A registration device, including:

a registration information input unit configured to receive registration information; and

an allowed information generation unit configured to generate at least one piece of allowed information as information associated with the registration information.

(Supplementary Note 7)

A storage device, including:

a registration information storage unit configured to store registration information as it is or after converting the registration information using a predetermined conversion function; and

an allowed information storage unit configured to store, as information associated with the registration information, at least one piece of allowed information as it is or after converting the allowed information using the predetermined conversion function.

(Supplementary Note 8)

A comparison device, including:

an authentication information acquisition unit configured to receive authentication information from an authentication device;

a current situation acquisition unit configured to acquire, from a situation management device, a current situation of an operator and/or of an overall system including relevant systems connected thereto;

a stored information acquisition unit configured to selectively acquire, from a storage device, stored information in accordance with the current situation;

an information comparison unit configured to compare the authentication information with the selected stored information to produce a compared result; and

a result determination unit configure to determine an authenticated result based on the compared result.

(Supplementary Note 9)

An authentication device, including:

an authentication information input unit configured to receive authentication information;

a current situation acquisition unit configured to receive, from a situation management device, a current situation of an operator and/or of an overall system including relevant systems connected thereto; and

an allowed information generation unit configured to generate allowed information from the authentication information in accordance with the current situation to produce, as comparison information, the allowed information as it is or after converting the allowed information using a predetermined conversion function.

(Supplementary Note 10)

A comparison device, including:

an authentication information acquisition unit configured to receive authentication information from an authentication device;

a current situation acquisition unit configured to acquire, from a situation management device, a current situation of an operator and/or of an overall system including relevant systems connected thereto;

a stored information acquisition unit configured to acquire registration information from a storage device;

an information comparison unit configured to compare the authentication information with the registration information based on an acceptance range in accordance with the current situation to produce a compared result; and

a result determination unit configure to determine an authenticated result based on the compared result.

(Supplementary Note 11)

A comparison method, comprising:

holding, in a situation management device, a current situation of an operator and/or of an overall system including relevant systems connected thereto;

receiving, by a registration device, registration information to store, as stored information in a storage device, at least one of the registration information and information associated with the registration information as it is or after converting the at least one using a predetermined conversion function;

receiving, by an authentication device, authentication information to produce, as comparison information, at least one of the authentication information and information associated with the authentication information as it is or after converting the last at least one using the predetermined conversion function; and comparing, by a comparison device, the stored information with the comparison information in accordance with the current situation.

(Supplementary Note 12)

The comparison method according to Supplementary Note 11,

wherein the registration device generates allowed information as the information associated with the registration information, and delivers, as the stored information to the storage device, a combination of the registration information and the allowed information as it is or after converting the combination using the predetermined conversion function,

wherein the authentication device delivers, as the comparison information to the comparison device, the authentication information as it is or after converting the authentication information using the predetermined conversion function, and

wherein the comparison device selects and receives the stored information stored in the storage device in accordance with the current situation, and compares the selected stored information with the authentication information.

(Supplementary Note 13)

The comparison method according to Supplementary Note 11,

wherein the registration device delivers, as the stored information to the storage device, the registration information as it is or after converting the registration information using the predetermined conversion function,

wherein the authentication device generates allowed information as the information associated with the authentication information based on a judgement in accordance with the current situation, and delivers, as the comparison information to the comparison device, at least one of the allowed information and the authentication information as it is or after converting the at least one using the predetermined conversion function,

wherein the comparison device compares the registration information received from the storage device with the comparison information received from the authentication device.

(Supplementary Note 14)

The comparison method according to any one of Supplementary Notes 11 to 13, wherein the comparison device determines an authentication level of the operator based on the current situation or a compared result of the information comparison unit.

(Supplementary Note 15)

A recording medium having recorded thereon a program for causing a computer to execute:

processing of holding a current situation of an operator and/or of an overall system including relevant systems connected thereto;

processing of receiving registration information and of storing, as stored information in a storage device, at least one of the registration information and information associated with the registration information as it is or after converting the at least one using a predetermined conversion function;

processing of receiving authentication information and of producing, as comparison information, at least one of the authentication information and information associated with the authentication information as it is or after converting the last at least one using the predetermined conversion function; and

processing of comparing the stored information with the comparison information in accordance with the current situation.

(Supplementary Note 16)

A registration method, including:

receiving, by a registration information input unit, registration information; and

generating, by an allowed information generation unit, at least one piece of allowed information as information associated with the registration information.

(Supplementary Note 17)

A comparison method, including:

receiving, by an authentication information acquisition unit, authentication information from an authentication device;

acquiring, by a current situation acquisition unit, from a situation management device, a current situation of an operator and/or of an overall system including relevant systems connected thereto;

selectively acquiring, by a stored information acquisition unit, from a storage device, stored information in accordance with the current situation;

comparing, by an information comparison unit, the authentication information with the selected stored information to produce a compared result; and

determining, by a result determination unit, an authenticated result based on the compared result.

(Supplementary Note 18)

An authentication method, including:

receiving, by an authentication information input unit, authentication information;

receiving, by a current situation acquisition unit, from a situation management device, a current situation of an operator and/or of an overall system including relevant systems connected thereto; and

generating, by an allowed information generation unit, allowed information from the authentication information in accordance with the current situation to produce, as comparison information, the allowed information as it is or after converting the allowed information using a predetermined conversion function.

(Supplementary Note 19)

A comparison method, including:

receiving, by an authentication information acquisition unit, authentication information from an authentication device;

acquiring, by a current situation acquisition unit, from a situation management device, a current situation of an operator and/or of an overall system including relevant systems connected thereto;

acquiring, by a stored information acquisition unit, registration information from a storage device;

comparing, by an information comparison unit, the authentication information with the registration information based on an acceptance range in accordance with the current situation to produce a compared result; and

determining, by a result determination unit, an authenticated result based on the compared result.

(Supplementary Note 20)

A recording medium having recorded thereon a registration program for causing a computer to execute:

registration information input processing of receiving registration information; and

allowed information generation processing of generating at least one piece of allowed information as information associated with the registration information.

(Supplementary Note 21)

A recording medium having recorded thereon a comparison program for causing a computer to execute:

authentication information acquisition processing of receiving authentication information from an authentication device;

current situation acquisition processing of acquiring, from a situation management device, a current situation of an operator and/or of an overall system including relevant systems connected thereto;

stored information acquisition processing of selectively acquiring, from a storage device, stored information in accordance with the current situation;

information comparison processing of comparing the authentication information with the selected stored information to produce a compared result; and

result determination processing of determining an authenticated result based on the compared result.

(Supplementary Note 22)

A recording medium having recorded thereon an authentication program for causing a computer to execute:

authentication information input processing of receiving authentication information;

current situation acquisition processing of receiving, from a situation management device, a current situation of an operator and/or of an overall system including relevant systems connected thereto; and

allowed information generation processing of generating allowed information from the authentication information in accordance with the current situation to produce, as comparison information, the allowed information as it is or after converting the allowed information using a predetermined conversion function.

(Supplementary Note 23)

A recording medium having recorded thereon a comparison program for causing a computer to execute:

authentication information acquisition processing of receiving authentication information from an authentication device;

current situation acquisition processing of receiving, from a situation management device, a current situation of an operator and/or of an overall system including relevant systems connected thereto;

stored information acquisition processing of acquiring registration information from a storage device;

information comparison processing of comparing the authentication information with the registration information based on an acceptance range in accordance with the current situation to produce a compared result; and

result determination processing of determining an authenticated result based on the compared result.

### INDUSTRIAL APPLICABILITY

This invention is applicable to an authentication system, such as authentication of an operator in an industrial control system, which is desired to perform the authentication of the operator according to different policies in a normal situation and in an abnormal situation. For example, this invention is usable in the industrial control system or the like in a case where normal ID/password authentication is performed in the normal situation whereas, upon occurrence of abnormality, it is desired to perform the ID/password authentication allowing some mistakes in entry of the password taking into account that user's mistakes will be increased. This invention is also applicable to a case where a different access authority is given to a user authenticated according to a different policy.

### REFERENCE SIGNS LIST

100 information processing system
110 situation management device
111 situation changing unit
112 situation holding unit
120 registration device
121 registration information input unit
122 allowed information generation unit
130 storage device
131 registration information storage unit
132 allowed information storage unit
140 authentication device
141 authentication information input unit
150 comparison device
151 authentication information acquisition unit
152 current situation acquisition unit
153 stored information acquisition unit
155 information comparison unit
156 result determination unit
200 information processing system
210 situation management device
211 situation changing unit
212 situation holding unit
220 registration device
221 registration information input unit
230 storage device
231 registration information storage unit
240 authentication device
241 authentication information input unit
242 current situation acquisition unit
243 allowed information generation unit
250 comparison device
251 comparison information acquisition unit
253 stored information acquisition unit
255 information comparison unit
256 result determination unit
300 information processing system
310 situation management device
311 situation changing unit
312 situation holding unit
320 registration device
321 registration information input unit
330 storage device
331 registration information storage unit
340 authentication device
341 authentication information input unit
350 comparison device
351 authentication information acquisition unit
352 current situation acquisition unit
353 stored information acquisition unit
355 information comparison unit
356 result determination unit

What is claimed is:

1. An information processing system, comprising:
a situation management device configured to hold a current situation of an operator and/or of an overall system including relevant systems connected to the information processing system;
a registration device configured to: receive registration information; and to store, as stored information in a storage device, at least one of the registration information and information associated with the registration information as it is or converted information obtained by converting the at least one using a predetermined conversion function;
an authentication device configured to: receive authentication information; and to produce, as comparison information, at least one of the authentication information and information associated with the authentication information as it is or converted information obtained by converting the last at least one using the predetermined conversion function; and
a comparison device configured to compare the stored information with the comparison information in accordance with the current situation.

2. The information processing system as claimed in claim 1,
wherein the registration device includes: a registration information input unit configured to receive the registration information; and an allowed information generation unit configured to generate allowed information as the information associated with the registration information, the registration device being configured to deliver, as the stored information to the storage device, a combination of the registration information and the allowed information as it is or a converted combination obtained by converting the combination using the predetermined conversion function,
wherein the storage device comprises: a registration information storage unit configured to store the registration information as a part of the stored information; and an allowed information storage unit configured to store the allowed information as a different part of the stored information,
wherein the authentication device includes an authentication information input unit configured to receive the authentication information, the authentication device being configured to deliver, as the comparison information to the comparison device, the authentication information as it is or converted authentication information obtained by converting the authentication information using the predetermined conversion function, and
wherein the comparison device includes: a stored information acquisition unit configured to selectively receive the stored information stored in the storage device in accordance with the current situation; and an information comparison unit configured to compare the selected stored information with the comparison information.

3. The information processing system as claimed in claim 1,
wherein the registration device includes a registration information input unit configured to receive the registration information, the registration device being configured to deliver, as the stored information to the storage device, the registration information as it is or converted registration information obtained by converting the registration information using the predetermined conversion function,
wherein the authentication device includes: an authentication information input unit configured to receive the authentication information; a current situation acquisition unit configured to receive the current situation from the situation management device; and an allowed information generation unit configured to generate allowed information as the information associated with the authentication information based on a judgement in accordance with the current situation, the authentication device being configured to deliver, as the comparison information to the comparison device, at least one of the allowed information and the authentication information as it is or converted information obtained by converting the at least one using the predetermined conversion function, and
wherein the comparison device includes an information comparison unit configured to compare the stored information received from the storage device with the comparison information received from the authentication device.

4. The information processing system as claimed in claim 1,
wherein the registration device includes a registration information input unit configured to receive the registration information, the registration device being configured to deliver, as the stored information to the storage device, the registration information as it is or converted registration information obtained by converting the registration information using the predetermined conversion function,
wherein the authentication device includes an authentication information input unit configured to receive the authentication information, the authentication device being configured to deliver, as the comparison information to the comparison device, the authentication information as it is or converted authentication information obtained by converting the authentication information using the predetermined conversion function, and
wherein the comparison device includes: a current situation acquisition unit configured to receive the current situation from the situation management device; and an information comparison unit configured to compare the stored information and the comparison information based on an acceptance range in accordance with the current situation.

5. The information processing system as claimed in claim 1, wherein the comparison device includes a result determination unit configured to determine an authentication level of the operator based on the current situation or a compared result of the comparison device.

6-7. (canceled)

8. A comparison device, comprising:
an authentication information acquisition unit configured to receive authentication information from an authentication device;
a current situation acquisition unit configured to acquire, from a situation management device, a current situation of an operator and/or of an overall system including relevant systems connected to an information processing system;
a stored information acquisition unit configured to selectively acquire, from a storage device, stored information in accordance with the current situation;
an information comparison unit configured to compare the authentication information with the selected stored information to produce a compared result; and
a result determination unit configure to determine an authenticated result based on the compared result.

9. (canceled)

10. A comparison device, comprising:
an authentication information acquisition unit configured to receive authentication information from an authentication device;
a current situation acquisition unit configured to acquire, from a situation management device, a current situation of an operator and/or of an overall system including relevant systems connected to an information processing system;
a stored information acquisition unit configured to acquire registration information from a storage device;
an information comparison unit configured to compare the authentication information with the registration information based on an acceptance range in accordance with the current situation to produce a compared result; and
a result determination unit configure to determine an authenticated result based on the compared result.

11. A comparison method, comprising:
holding, in a situation management device, a current situation of an operator and/or of an overall system including relevant systems connected to an information processing system;
receiving, by a registration device, registration information to store, as stored information in a storage device, at least one of the registration information and information associated with the registration information as it is or converted information obtained by converting the at least one using a predetermined conversion function;
receiving, by an authentication device, authentication information to produce, as comparison information, at least one of the authentication information and information associated with the authentication information as it is or converted information obtained by converting the last at least one using the predetermined conversion function; and
comparing, by a comparison device, the stored information with the comparison information in accordance with the current situation.

12. The comparison method as claimed in claim 11,
wherein the registration device generates allowed information as the information associated with the registration information, and delivers, as the stored information to the storage device, a combination of the registration information and the allowed information as it is or a converted combination obtained by converting the combination using the predetermined conversion function,
wherein the authentication device delivers, as the comparison information to the comparison device, the authentication information as it is or converted authentication information obtained by converting the authentication information using the predetermined conversion function, and
wherein the comparison device selects and receives the stored information stored in the storage device in accordance with the current situation, and compares the selected stored information with the comparison information.

13. The comparison method as claimed in claim 11,
wherein the registration device delivers, as the stored information to the storage device, the registration information as it is or converted registration information obtained by converting the registration information using the predetermined conversion function,
wherein the authentication device generates allowed information as the information associated with the authentication information based on a judgement in accordance with the current situation, and delivers, as the comparison information to the comparison device, at least one of the allowed information and the authentication information as it is or converted information obtained by converting the at least one using the predetermined conversion function,
wherein the comparison device compares the stored information received from the storage device with the comparison information received from the authentication device.

14. The comparison method as claimed in claim 11, wherein the comparison device determines an authentication level of the operator based on the current situation or a compared result of the comparison device.

15. A non-transitory recording medium having recorded thereon a program for causing a computer to execute:
processing of holding a current situation of an operator and/or of an overall system including relevant systems connected to an information processing system;
processing of receiving registration information and of storing, as stored information in a storage device, at least one of the registration information and information associated with the registration information as it is or converted information obtained by converting the at least one using a predetermined conversion function;
processing of receiving authentication information and of producing, as comparison information, at least one of the authentication information and information associated with the authentication information as it is or converted information obtained by converting the last at least one using the predetermined conversion function; and
processing of comparing the stored information with the comparison information in accordance with the current situation.

16-23. (canceled)
